(19) United States
(12) Patent Application Publication
(10) Pub. No.: US 2023/0290970 A1
(43) Pub. Date: Sep. 14, 2023

(54) FUEL CELL SYSTEM

(71) Applicant: HONDA MOTOR CO., LTD., TOKYO (JP)

(72) Inventors: Shinya WATANABE, WAKO-SHI (JP); Tomohito KOTAKE, WAKO-SHI (JP); Eri TERADA, WAKO-SHI (JP); Kazuyuki TAKAHASHI, WAKO-SHI (JP); Masahiro MOHRI, WAKO-SHI (JP)

(21) Appl. No.: 18/114,259

(22) Filed: Feb. 26, 2023

(30) Foreign Application Priority Data
Mar. 8, 2022 (JP) 2022-034968

(51) Int. Cl. H01M 8/04119; H01M 8/04492; H01M 8/1004; H01M 8/0267

(52) U.S. Cl. CPC H01M 8/04126; H01M 8/04507; H01M 8/045; H01M 8/1004; H01M 8/0267

(57) ABSTRACT

The fuel cell system determines whether or not condensation is occurring in the anode gas and the cathode gas on the basis of the humidity of the cathode gas detected by a first humidity sensor provided in the power generation cells and the humidity of the anode gas detected by a second humidity sensor provided in the power generation cells, and adjusts the water content in the cathode gas and/or the anode gas in which condensation is occurring.

### CROSS-REFERENCE TO RELATED APPLICATIONS

This application is based upon and claims the benefit of priority from Japanese Patent Application No. 2022-034968 filed on Mar. 8, 2022, the contents of which are incorporated herein by reference.

### BACKGROUND OF THE INVENTION

### Field of the Invention

The present invention relates to a fuel cell system.

### Description of the Related Art

In the fuel cell system, an anode gas (hydrogen gas) and a cathode gas (oxygen gas) are supplied to a fuel cell stack so that the fuel cell stack generates power. The fuel cell stack generates power by electrochemical reactions between the anode gas and the cathode gas.

JP 2007-035389 A discloses an operation method for a fuel cell system. In this operation method, the amount of water in the fuel cell stack (fuel cells) is estimated, and the purge process is executed based on the estimation result. In the scavenging process, a purge gas is supplied to the fuel cell stack when the ignition is turned off.

### SUMMARY OF THE INVENTION

However, in the above operation method, the amount of water in the fuel cell stack is estimated. If the estimated amount of water is greatly different from the amount of water actually retained in the fuel cell stack, the water in the fuel cell stack cannot be decreased.

An object of the present invention is to solve the above-described problems.

An aspect of the present invention is a fuel cell system configured to adjust a water content in a cathode gas and an anode gas supplied to a fuel cell stack including a plurality of power generation cells stacked together, comprising: a first humidity sensor disposed inside at least one of the power generation cells and configured to detect humidity of the cathode gas; a second humidity sensor disposed inside at least one of the power generation cells and configured to detect humidity of the anode gas; and a controller configured to determine, on a basis of the humidity of the cathode gas detected by the first humidity sensor and the humidity of the anode gas detected by the second humidity sensor, whether the anode gas and the cathode gas are in a state in which condensation is occurring, and in a case where at least one of the cathode gas or the anode gas is determined to be in the state in which condensation is occurring, decrease a water content in the at least one of the cathode gas or the anode gas.

According to the aspect of the present invention, since the humidity sensor is provided inside the power generation cells, the amount of water in the power generation cells can be accurately detected. In addition, according to the aspect of the present invention, it is possible to suppress accumulation of liquid water inside the power generation cells by decreasing the water content in the gas determined to be in the state in which condensation is occurring, even if the ignition is turned on. In this way, the amount of water accumulated inside the fuel cell stack can be reduced.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram illustrating a configuration of a fuel cell system according to a first embodiment;

FIG. 2 is a schematic cross-sectional view of a power generation cell;

FIG. 3 is a cross-sectional view taken along line III-III of FIG. 2;

FIG. 4 is a view illustrating a first separator member;

FIG. 5 is a view illustrating a second separator member;

and

FIG. 6 is a diagram illustrating locations of a first humidity sensor and a second humidity sensor according to a second embodiment.

### DETAILED DESCRIPTION OF THE INVENTION

### First Embodiment

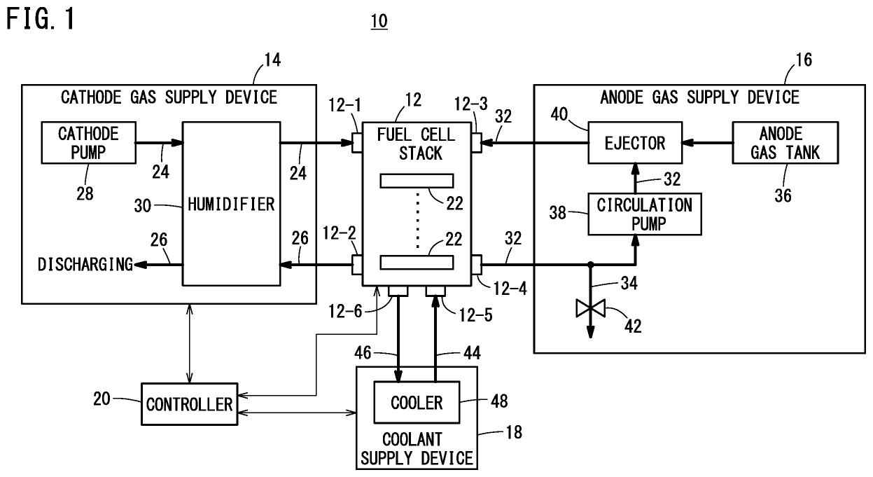

FIG. 1 is a schematic diagram illustrating a configuration of a fuel cell system 10 according to the first embodiment. The fuel cell system 10 is mounted on a moving object. Examples of the moving object include a vehicle, a submarine, a spacecraft, a ship, an aircraft, and a robot. The vehicle may be a four wheeled vehicle (automobile) or may be a two wheeled vehicle or a three wheeled vehicle.

The fuel cell system 10 includes a fuel cell stack 12, a cathode gas supply device 14, an anode gas supply device 16, a coolant supply device 18, and a controller 20.

The fuel cell stack 12 includes a plurality of power generation cells 22. The plurality of power generation cells 22 are stacked to form a stack body. Each power generation cell 22 generates electric power by electrochemical reactions between the cathode gas and the anode gas. The cathode gas is an oxygen-containing gas containing oxygen as air, and the anode gas is a fuel gas containing hydrogen or the like.

The fuel cell stack 12 includes a cathode gas input unit 12-1 for inputting the cathode gas and a cathode gas output unit 12-2 for outputting the cathode gas. The fuel cell stack 12 includes an anode gas input unit 12-3 for inputting the anode gas, and an anode gas output unit 12-4 for outputting the anode gas. Further, the fuel cell stack 12 includes a coolant input unit 12-5 for inputting a coolant and a coolant output unit 12-6 for outputting the coolant. The coolant may be liquid or gas as long as it is a medium capable of cooling the heat generated by the fuel cell stack 12.

The cathode gas supply device 14 supplies the cathode gas to the fuel cell stack 12. The cathode gas supply device 14 includes a cathode supply path 24, a cathode discharge path 26, a cathode pump 28, and a humidifier 30.

One end of the cathode supply path 24 is connected to the cathode pump 28, and the other end of the cathode supply path 24 is connected to the cathode gas input unit 12-1 of the fuel cell stack 12. The cathode gas flowing through the cathode supply path 24 is supplied to each power generation cell 22.

One end of the cathode discharge path 26 is connected to the cathode gas output unit 12-2, and the other end of the cathode discharge path 26 is open to the atmosphere. The cathode gas flowing out from each power generation cell 22 is discharged to the cathode discharge path 26.

The cathode pump 28 supplies the cathode gas to the cathode supply path 24. The amount of the cathode gas to be supplied is adjustable by the cathode pump 28. The controller 20 controls the amount of the cathode gas supplied by the cathode pump 28.

The humidifier 30 humidifies the cathode gas flowing through the cathode supply path 24 with water collected from the cathode discharge path 26. The degree of humidification of the cathode gas is adjustable by the humidifier 30. The controller 20 controls the degree of humidification of the cathode gas.

For example, the humidifier 30 includes a recovery unit disposed on the cathode discharge path 26, a humidification unit disposed on the cathode supply path 24, a bypass path bypassing the humidification unit, and an on-off valve provided in the bypass path. The humidification unit generates water vapor from the water collected by the collection unit and supplies the generated water vapor to the cathode supply path 24. The bypass path is branched off from the cathode supply path 24 at a portion closer to the cathode pump 28 than the humidification unit, and connected to the cathode supply path 24 at a portion closer to the fuel cell stack 12 than the humidification unit, without passing through the humidification unit. In this case, the humidifier 30 can adjust the amount of humidification of the cathode gas by adjusting the amount of cathode gas supplied to the humidification unit in accordance with the opening degree of the on-off valve. The opening degree of the on-off valve is controlled by the controller 20.

The anode gas supply device 16 supplies the anode gas to the fuel cell stack 12 and collects the anode gas discharged from the fuel cell stack 12. The anode gas supply device 16 includes a circulation path 32, a purge path 34, an anode gas tank 36, a circulation pump 38, an ejector 40, and a discharge valve 42.

One end of the circulation path 32 is connected to the anode gas input unit 12-3 of the fuel cell stack 12, and the other end of the circulation path 32 is connected to the anode gas output unit 12-4 of the fuel cell stack 12. The anode gas flowing in from the anode gas input unit 12-3 is supplied to each power generation cell 22. The anode gas flowing out from each power generation cell 22 is discharged to the circulation path 32 through the anode gas output unit 12-4. The circulation pump 38 is provided in the circulation path 32. The ejector 40 is provided in the circulation path 32 between the circulation pump 38 and the anode gas input unit 12-3.

The purge path 34 is branched from the circulation path 32 between the anode gas output unit 12-4 and the circulation pump 38. The purge path 34 is provided with the discharge valve 42.

The anode gas tank 36 stores the anode gas. The anode gas tank 36 can supply the anode gas to the circulation path 32, and the amount of the anode gas to be supplied is adjustable using the anode gas tank 36. The controller 20 controls the amount of the anode gas to be supplied.

For example, the anode gas tank 36 includes an anode gas supply path connected to the circulation path 32 and the anode gas tank 36, and a flow control valve provided on the anode gas supply path. In this case, the amount of the anode gas to be supplied is adjustable by the anode gas tank 36 by adjusting the flow rate of the flow control valve. The flow control valve is controlled by the controller 20.

The circulation pump 38 discharges the anode gas from the fuel cell stack 12 and supplies it to the ejector 40 via the circulation path 32. The amount of the anode gas to be supplied is adjustable by the circulation pump 38. The controller 20 controls the amount of the anode gas to be supplied by the circulation pump 38.

The anode gas supplied from the anode gas tank 36 or the circulation pump 38 is supplied to the fuel cell stack 12 by the ejector 40.

The discharge valve 42 is configured to be openable and closable. When the discharge valve 42 is open, the anode gas discharged from the fuel cell stack 12 to the circulation path 32 flows to the purge path 34. On the other hand, when the discharge valve 42 is closed, the anode gas discharged from the fuel cell stack 12 to the circulation path 32 flows through the circulation pump 38. The opening and closing of the discharge valve 42 is controlled by the controller 20.

The coolant supply device 18 cools the fuel cell stack 12. The coolant supply device 18 includes a coolant supply path 44, a coolant discharge path 46, and a cooler 48.

One end of the coolant supply path 44 is connected to the cooler 48, and the other end of the coolant supply path 44 is connected to the coolant input unit 12-5. The coolant flowing through the coolant supply path 44 is supplied between the power generation cells 22.

One end of the coolant discharge path 46 is connected to the coolant output unit 12-6, and the other end of the coolant discharge path 46 is connected to the cooler 48. The coolant flowing between the power generation cells 22 flows out from the coolant output unit 12-6 to the coolant discharge path 46.

The cooler 48 cools the coolant discharged from the fuel cell stack 12 via the coolant discharge path 46, and supplies the cooled coolant to the fuel cell stack 12 via the coolant supply path 44. The cooler 48 is configured to adjust the temperature of the coolant supplied to the fuel cell stack 12. The temperature of the coolant is controlled by the controller 20.

For example, the cooler 48 includes a radiator provided between the coolant discharge path 46 and the coolant supply path 44, a radiator bypass path that bypasses the radiator, and an on-off valve provided in the radiator bypass path. The radiator cools the coolant discharged via the coolant discharge path 46 and causes the cooled coolant to flow to the coolant supply path 44. The radiator bypass path is branched off from the coolant discharge path 46 at a portion closer to the fuel cell stack 12 than the radiator and connected to the coolant supply path 44 at a portion closer to the fuel cell stack 12 than the radiator, without passing through the radiator. In this case, the cooler 48 can adjust the temperature of the coolant by adjusting the amount of coolant supplied to the radiator in accordance with the opening degree of the on-off valve. The opening degree of the on-off valve is controlled by the controller 20.

The controller 20 comprehensively controls the entire fuel cell system 10. The controller 20 can execute a power generation operation for generating power in the fuel cell stack 12. For example, when a power generation execution command is given from an input device (not shown), the controller 20 executes a power generation operation. In this case, the controller 20 supplies electric current to each power generation cell 22. The controller 20 controls the cathode gas supply device 14 to supply cathode gas to the fuel cell stack 12, and controls the anode gas supply device 16 to supply anode gas to the fuel cell stack 12.

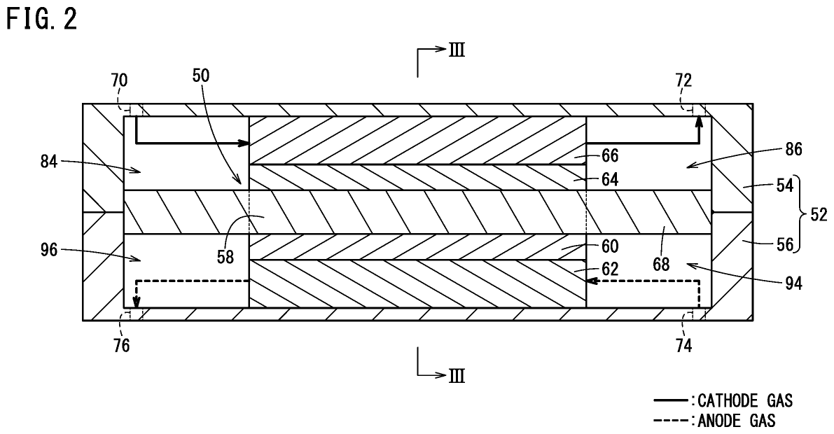

FIG. 2 is a schematic cross-sectional view of a power generation cell 22. The power generation cell 22 is a solid polymer electrolyte fuel cell. The power generation cell 22 includes a membrane electrode assembly 50 and separator 52. The membrane-electrode assembly 50 is hereinafter referred to as MEA 50. The separator 52 includes a first separator member 54 and a second separator member 56. The separator 52 is formed by joining the first separator member 54 and the second separator member 56. The separator 52 sandwiches the MEA 50.

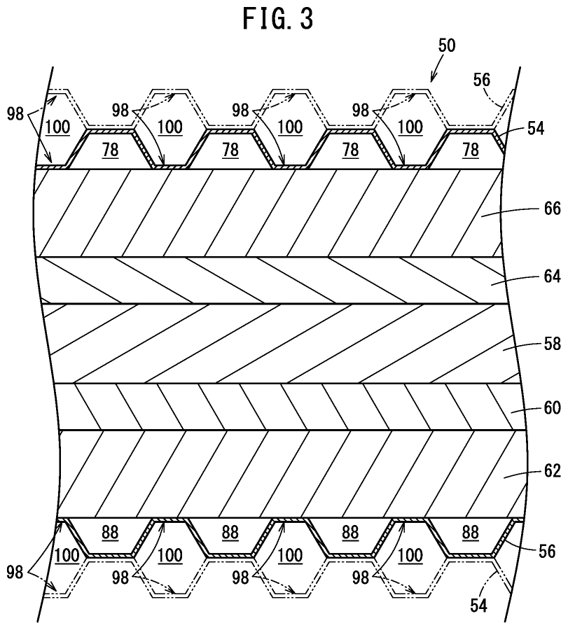

FIG. 3 is a cross-sectional view taken along line III-III of FIG. 2. The MEA 50 includes an electrolytic membrane 58, an anode catalyst layer 60, an anode diffusion layer 62, a cathode catalyst layer 64, a cathode diffusion layer 66 and an outer frame film 68 (see FIG. 2).

The electrolyte membrane 58 is constituted by a solid polymer electrolyte membrane or the like. The anode catalyst layer 60 is provided on one surface of the electrolyte membrane 58. The anode diffusion layer 62 is provided on a surface of the anode catalyst layer 60 opposite to the surface facing the electrolyte membrane 58. The cathode catalyst layer 64 is provided on the other surface of the electrolyte membrane 58. The cathode diffusion layer 66 is provided on a surface of the cathode catalyst layer 64 opposite to the surface facing the electrolyte membrane 58.

The outer frame film 68 (FIG. 2) is a member serving as an outer frame of the MEA 50. The outer frame film 68 may be the electrolyte membrane 58 (see FIG. 2). In this case, the electrolyte membrane 58 is formed so as to protrude outward from the anode catalyst layer 60, the anode diffusion layer 62, the cathode catalyst layer 64, and the cathode diffusion layer 66. The outer frame film 68 may be a resin film (not shown). In this case, the resin film may be connected to the outer peripheral portion of the electrolyte membrane 58, or may be sandwiched between the outer peripheral portion of the anode catalyst layer 60 and the outer peripheral portion of the cathode catalyst layer 64.

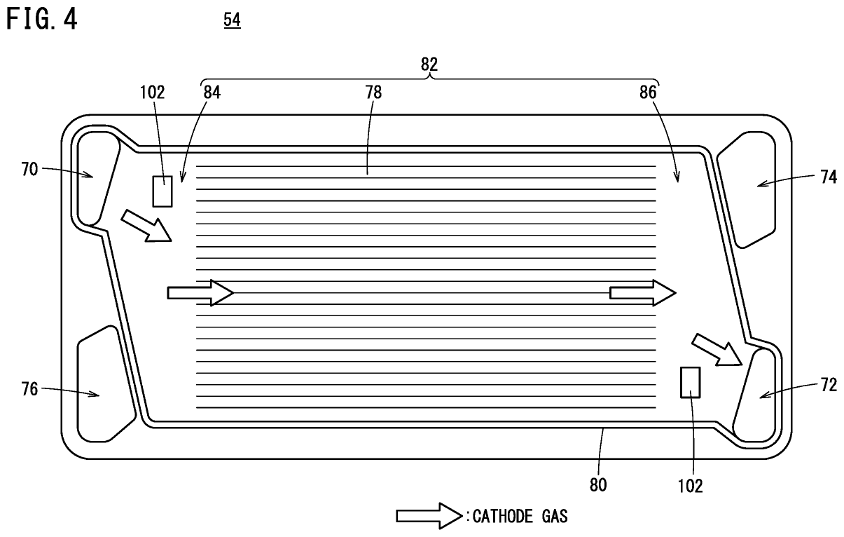

FIG. 4 is a view showing the first separator member 54. The first separator member 54 has a cathode inlet hole 70, a cathode outlet hole 72, an anode inlet hole 74 and an anode outlet hole 76. The cathode inlet hole 70, the cathode outlet hole 72, the anode inlet hole 74, and the anode outlet hole 76 are spaced apart from one another.

The cathode inlet hole 70 communicates with the cathode supply path 24 (FIG. 1) via a cathode input path (not shown) provided inside the fuel cell stack 12. The cathode outlet hole 72 communicates with the cathode discharge path 26 (FIG. 1) via a cathode output path provided inside the fuel cell stack 12.

The anode inlet hole 74 communicates with the circulation path 32 (FIG. 1) via an anode input path (not shown) provided inside the fuel cell stack 12. The anode outlet hole 76 communicates with the circulation path 32 via an anode output path provided inside the fuel cell stack 12.

The cathode inlet hole 70 and the anode outlet hole 76 are located, for example, at a first edge portion of the first separator member 54. The cathode outlet hole 72 and the anode inlet hole 74 are located, for example, at a second edge portion of the first separator member 54. The second edge portion is opposed to the first edge portion.

A plurality of grooves 78 are formed in the inner surface of the first separator member 54. The inner surface of the first separator member 54 faces the MEA 50. The plurality of grooves 78 are disposed substantially at the center of the inner surface of the first separator member 54 and extend along the longitudinal direction of the first separator member 54.

A first line seal member 80 is provided on the inner surface of the first separator member 54. The first line seal member 80 surrounds the plurality of grooves 78, the cathode inlet hole 70 and the cathode outlet hole 72. A cathode gas flow field 82 is formed in an area surrounded by the first line seal member 80 between the MEA 50 and the first separator member 54.

The cathode gas flow field 82 includes a cathode inlet space 84, a cathode outlet space 86, and the plurality of grooves 78. The cathode inlet space 84 is a space between the outer frame film 68 and the first separator member 54 and communicates with the cathode inlet hole 70 (see FIG. 2). The cathode outlet space 86 is a space between the outer frame film 68 and the first separator member 54 and communicates with the cathode outlet hole 72 (see FIG. 2). The plurality of grooves 78 communicate with the cathode inlet space 84 and the cathode outlet space 86 (see FIG. 4).

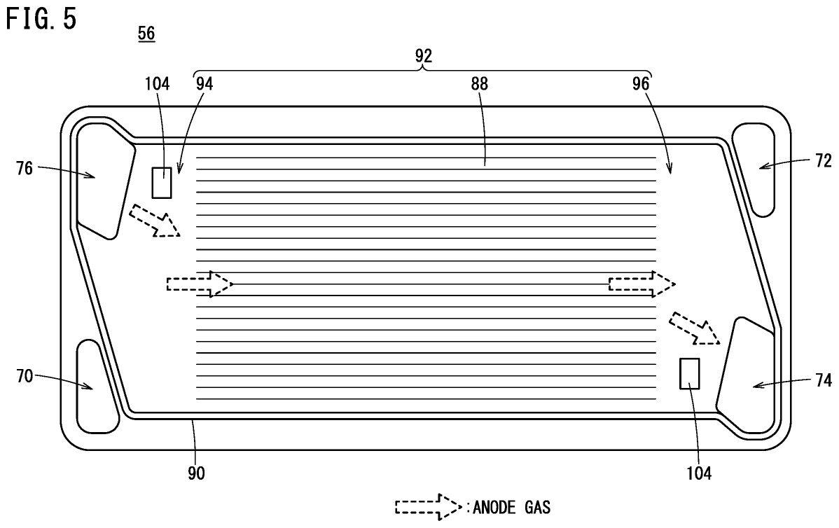

FIG. 5 is a view showing the second separator member 56. The second separator member 56 has the cathode inlet hole 70, the cathode outlet hole 72, the anode inlet hole 74 and the anode outlet hole 76 at positions corresponding to the respective holes of the first separator member 54.

A plurality of grooves 88 are formed in the inner surface of the second separator member 56. The plurality of grooves 88 are disposed substantially at the center of the inner surface of the second separator member 56 and extend along the longitudinal direction of the second separator member 56.

A second line seal member 90 is provided on the inner surface of the second separator member 56. The second line seal member 90 surrounds the plurality of grooves 88, the anode inlet hole 74 and the anode outlet hole 76. An anode gas flow field 92 is formed in an area surrounded by the second line seal member 90 between the MEA 50 and the second separator member 56.

The anode gas flow field 92 includes an anode inlet space 94, an anode outlet space 96, and the plurality of grooves 88. The anode inlet space 94 is a space between the outer frame film 68 and the second separator member 56 and communicates with the anode inlet hole 74 (see FIG. 2). The anode outlet space 96 is a space between the outer frame film 68 and the second separator member 56 and communicates with the anode outlet hole 76 (see FIG. 2). The plurality of grooves 88 communicate with the anode inlet space 94 and the anode outlet space 96 (see FIG. 5).

A plurality of grooves 98 (see FIG. 3) are formed on the outer surface of the first separator member 54 and the outer surface of the second separator member 56. The outer surface of the first separator member 54 is a surface opposite to the inner surface of the first separator member 54, and the outer surface of the second separator member 56 is a surface opposite to the inner surface of the second separator member 56.

When another power generation cell 22 is arranged adjacent to the first separator member 54, the grooves 98 formed on the outer surface of the first separator member 54 and the grooves 98 formed on the outer surface of the second separator member 56 of the other power generation cell 22 constitute a coolant flow field 100. Similarly, when another power generation cell 22 is arranged adjacent to the second separator member 56, the grooves 98 formed on the outer surface of the second separator member 56 and the grooves 98 formed on the outer surface of the first separator member 54 of the other power generation cell 22 constitute the coolant flow field 100.

The coolant flows into the coolant flow field 100 from a coolant inlet path (not shown) provided inside the fuel cell stack 12. The coolant inlet path is connected to the coolant supply path 44 (FIG. 1) of the coolant supply device 18. The coolant having flowed through the coolant flow field 100 flows out to a coolant outlet path (not shown) provided inside the fuel cell stack 12. The coolant outlet path is connected to the coolant discharge path 46 (FIG. 1) of the coolant supply device 18. The coolant, the anode gas, and the cathode gas are not mixed with each other inside the fuel cell stack 12.

The fuel cell system 10 further includes a first humidity sensor 102 (FIG. 4) for detecting the humidity (relative humidity) of the cathode gas and a second humidity sensor 104 (FIG. 5) for detecting the humidity (relative humidity) of the anode gas. In the present embodiment, the first humidity sensor 102 and the second humidity sensor 104 are provided in one of the plurality of power generation cells 22.

The first humidity sensor 102 is provided in each of the cathode inlet space 84 and the cathode outlet space 86 of the cathode gas flow field 82. Each first humidity sensor 102 is formed to be thin, for example, and is attached to the inner surface of the first separator member 54. On the other hand, the second humidity sensor 104 is provided in each of the anode inlet space 94 and the anode outlet space 96 of the anode gas flow field 92. Each second humidity sensor 104 is formed to be thin, for example, and attached to the inner surface of the second separator member 56.

As described above, the first humidity sensors 102 are provided in the cathode gas flow field 82 in the power generation cell 22, and the second humidity sensors 104 are provided in the anode gas flow field 92 in the power generation cell 22. Thus, the amount of water in the power generation cell 22 can be detected more accurately than in the case where the sensor is provided outside the power generation cell 22.

The controller 20 determines whether condensation is occurring in the cathode gas on the basis of the humidity detected by each first humidity sensor 102. The controller 20 makes the determination during the power generation operation of the fuel cell stack 12. For example, if the humidity detected by at least one of the respective first humidity sensors 102 exceeds the first threshold value, then the controller 20 may determine that the cathode gas is in the condensation state in which condensation is occurring in the cathode gas. Alternatively, the controller 20 may determine that the cathode gas is in the condensation state in which condensation is occurring in the cathode gas if a difference in humidity detected by the respective first humidity sensors 102 exceeds a first threshold value. Alternatively, the controller 20 may determine that the cathode gas is in the condensation state in which condensation is occurring in the cathode gas if an average of the humidity detected by the respective first humidity sensors 102 per unit time exceeds the first threshold value. The first threshold is set to, for example, 100%.

If it is determined that the cathode gas is in the condensation state, the controller 20 reduces the water content in the cathode gas. In this case, the controller 20 executes at least one of the gas increasing operation and the humidification decreasing operation. The gas increasing operation is an operation of controlling the cathode pump 28 to increase the cathode gas supply from the amount supplied at the time when it is determined that the cathode gas is in the condensation state. The humidification decreasing operation is an operation of controlling the humidifier 30 to decrease the extent of the humidification of the cathode gas from that at the time when it is determined that the cathode gas is in the condensation state.

As described above, the controller 20 determines whether or not the cathode gas is in the condensation state during the power generation operation of the fuel cell stack 12, and reduces the water content in the cathode gas when the cathode gas is in the condensation state. Thus, even if the purge gas is not supplied when the power generation operation is stopped, it is possible to suppress the liquid water from being retained in the power generation cell 22.

On the other hand, the controller 20 determines whether condensation is occurring in the anode gas on the basis of the humidity detected by each second humidity sensor 104. The controller 20 makes the determination during the power generation operation of the fuel cell stack 12. For example, if the humidity detected by at least one of the respective second humidity sensors 104 exceeds the second threshold value, then the controller 20 may determine that the anode gas is in the condensation state in which condensation is occurring in the anode gas. Alternatively, the controller 20 may determine that the anode gas is in the condensation state in which condensation is occurring in the anode gas if a difference in humidity detected by the respective second humidity sensors 104 exceeds a second threshold value. Alternatively, the controller 20 may determine that the anode gas is in the condensation state in which condensation is occurring in the anode gas if an average of humidity detected by the respective second humidity sensors 104 per unit time exceeds the second threshold value. The second threshold is set to, for example, 100%.

If it is determined that the anode gas is in the condensation state, the controller 20 reduces the water content in the anode gas. In this case, the controller 20 opens the discharge valve 42 to allow the anode gas discharged from the fuel cell stack 12 to flow into the purge path 34. At the same time, the controller 20 executes at least one of the gas supply operation and the gas increasing operation.

The gas supply operation is an operation of controlling the anode gas tank 36 to supply the anode gas to the ejector 40. The gas increasing operation is an operation of controlling the circulation pump 38 to increase the amount of the anode gas to be supplied to the ejector 40.

In the gas supply operation, the controller 20 may supply the anode gas in an amount corresponding to the amount of the anode gas having flowed to the purge path 34. In this case, a flow rate sensor for detecting the amount of the anode gas is provided in the purge path 34. The controller 20 supplies the anode gas from the anode gas tank 36 to the ejector 40 based on the amount of the anode gas detected by the flow rate sensor.

As described above, the controller 20 determines whether or not the anode gas is in the condensation state during the power generation operation of the fuel cell stack 12, and reduces the water content in the anode gas when the anode gas is in the condensation state. Thus, even if the purge gas is not supplied when the power generation operation is stopped, it is possible to suppress the liquid water from being retained in the power generation cell 22.

### Second Embodiment

In the second embodiment, descriptions that have been made in the first embodiment is omitted. In the present embodiment, the locations of the first humidity sensors 102 and the second humidity sensors 104 are different from those in the first embodiment.

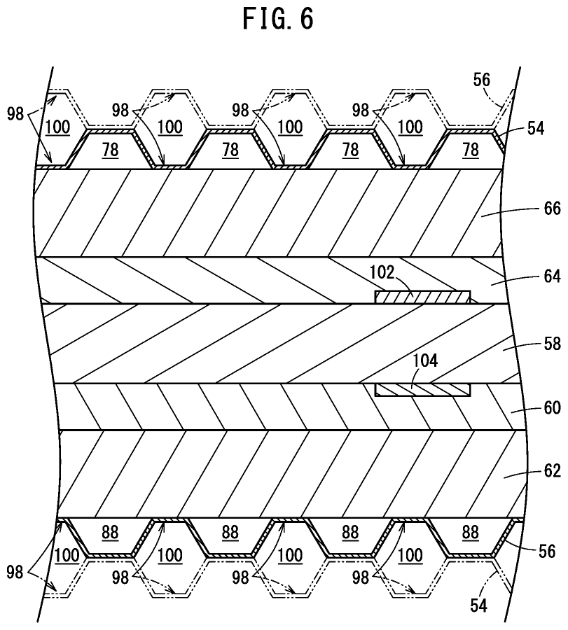

FIG. 6 is a diagram showing the locations of the first humidity sensor 102 and the second humidity sensor 104 according to the second embodiment. FIG. 6 is a cross-sectional view taken along line III-III of FIG. 2. In the present embodiment, the first humidity sensor 102 and the second humidity sensor 104 are provided inside the MEA 50.

The first humidity sensor 102 is provided in at least one of a first cathode interlayer portion, a second cathode interlayer portion, and a third cathode interlayer portion. The first cathode interlayer portion corresponds to the portion between the electrolyte membrane 58 and the cathode catalyst layer 64. The second cathode interlayer portion corresponds to the portion between the cathode catalyst layer 64 and the cathode diffusion layer 66. The third cathode interlayer portion corresponds to the portion between the separator 52 (the first separator member 54) and the cathode diffusion layer 66. The third cathode interlayer portion may correspond to a portion between the first separator member 54 and the cathode diffusion layer 66 in which the groove 78 is formed or may correspond to a portion between the first separator member 54 and the cathode diffusion layer 66 in which the groove 98 is formed. FIG. 6 shows an example in which the first humidity sensor 102 is provided in the first cathode interlayer portion.

When a plurality of the first humidity sensors 102 are provided in two or more cathode interlayer portions, the controller 20 determines whether or not concentration occurs in the cathode gas on the basis of the humidity detected by respective first humidity sensors 102. For example, if the humidity detected by at least one of the respective first humidity sensors 102 exceeds the first threshold value, or if a difference, a sum, an average, or the like of the humidity detected by the first humidity sensors 102 exceeds the first threshold value, then the controller 20 determines that the cathode gas is in the condensation state in which condensation is occurring in the cathode gas.

In the case where the first humidity sensor 102 is provided in one cathode interlayer portion, the controller 20 determines that the cathode gas is in the condensation state if the humidity detected by the first humidity sensor 102 exceeds the first threshold value.

The second humidity sensor 104 is provided in at least one of a first anode interlayer portion, a second anode interlayer portion, and a third anode interlayer portion. The first anode interlayer portion corresponds to the portion between the electrolyte membrane 58 and the anode catalyst layer 60. The second anode interlayer portion corresponds to the portion between the anode catalyst layer 60 and the anode diffusion layer 62. The third anode interlayer portion corresponds to the portion between the separator 52 (the second separator member 56) and the anode diffusion layer 62. The third anode interlayer portion may correspond to a portion between the second separator member 56 and the anode diffusion layer 62 in which the groove 88 is formed or may correspond to a portion between the second separator member 56 and the anode diffusion layer 62 in which the groove 98 is formed. FIG. 6 shows an example in which the second humidity sensor 104 is provided in the first anode interlayer portion.

When a plurality of the second humidity sensors 104 are provided in two or more anode interlayer portions, the controller 20 determines whether or not concentration occurs in the anode gas on the basis of the humidity detected by respective second humidity sensors 104. For example, if the humidity detected by at least one of the respective second humidity sensors 104 exceeds the second threshold value, or if a difference, a sum, an average, or the like of the humidity detected by the second humidity sensors 104 exceeds the second threshold value, then the controller 20 determines that the anode gas is in the condensation state in which condensation is occurring in the anode gas.

In the case where the second humidity sensor 104 is provided in one anode interlayer portion, the controller 20 determines that the anode gas is in the condensation state if the humidity detected by the second humidity sensor 104 exceeds the second threshold value.

In the present embodiment, the first humidity sensor 102 and the second humidity sensor 104 are provided inside the MEA 50. Thus, it is possible to locally detect a portion of the power generation cell 22 where liquid water is likely to be retained.

The first embodiment or the second embodiment may be modified as described below.

### Modified Example 1

When it is determined that at least one of the cathode gas and the anode gas is in the condensation state, the controller 20 may control the cooler 48 to perform a coolant temperature increasing operation of increasing the temperature of the coolant. As a result, compared to a case where the coolant temperature increasing operation is not executed, it is possible to resolve condensation more quickly.

### Modified Example 2

Both the first humidity sensor 102 of the first embodiment and the first humidity sensor 102 of the second embodiment may be employed. In this case, the controller 20 determines whether or not condensation is occurring in the cathode gas on the basis of the detection results of the at least one first humidity sensor 102 provided in the cathode gas flow field 82 and the at least one first humidity sensor 102 provided inside the MEA 50.

For example, if a difference, a sum, an average, or the like of the humidity detected by the first humidity sensor 102 provided in the cathode gas flow field 82 and detected by the first humidity sensor 102 provided inside the MEA 50 exceeds the first threshold value, then the controller 20 determines that the cathode gas is in the condensation state in which condensation is occurring in the cathode gas.

Similarly, both the second humidity sensor 104 of the first embodiment and the second humidity sensor 104 of the second embodiment may be employed. In this case, the controller 20 determines whether or not condensation is occurring in the anode gas on the basis of the detection results of the at least one second humidity sensor 104 provided in the anode gas flow field 92 and the at least one second humidity sensor 104 provided inside the MEA 50.

For example, if a difference, a sum, an average, or the like of the humidity detected by the second humidity sensor 104 provided in the anode gas flow field 92 and detected by the second humidity sensor 104 provided inside the MEA 50 exceeds the second threshold value, then the controller 20 determines that the anode gas is in the condensation state in which condensation is occurring in the anode gas.

### Modified Example 3

The first humidity sensors 102 and the second humidity sensors 104 may be provided in the plurality of power generation cells 22. In this case, if a difference, a sum, an average, or the like of the humidity detected by the first humidity sensors 102 provided in a plurality of power generation cells 22 exceeds the first threshold value, then the controller 20 determines that the cathode gas is in the condensation state in which condensation is occurring in the cathode gas. Similarly, if a difference, a sum, an average, or the like of the humidity detected by the second humidity sensors 104 provided in a plurality of power generation cells 22 exceeds the second threshold value, then the controller 20 determines that the anode gas is in the condensation state in which condensation is occurring in the anode gas.

In the plurality of power generation cells 22, a temperature difference tends to occur during the power generation operation of the fuel cell stack 12. That is, among the plurality of stacked power generation cells 22, the temperature of the power generation cell 22 located at the center in the stacking direction tends to be the highest. On the other hand, the temperatures of the power generation cells 22 located on both ends in the stacking direction tend to be the lowest among the plurality of stacked power generation cells 22.

Therefore, the first humidity sensor 102 and the second humidity sensor 104 may be provided for each of the power generation cells 22 located on both ends in the stacking direction of the power generation cells 22 and for the power generation cell 22 located at the center in the stacking direction of the power generation cells 22. In this manner, it is possible to set the determination condition for determining the condensation state in consideration of the temperature difference occurring in the plurality of power generation cells 22 during the power generation operation by the fuel cell stack 12.

The determination condition is a first threshold, a second threshold, or the like. In a case where the determination condition is changed, the controller 20 changes the first threshold value, the second threshold value, and the like to the values given from an input device (not illustrated) according to an operation by the user.

A description will be given below concerning technical concepts and effects that are capable of being grasped from the above descriptions.

An aspect of the present invention is the fuel cell system (10) configured to adjust a water content in a cathode gas and an anode gas supplied to the fuel cell stack (12) including the plurality of power generation cells (22) stacked together, comprising: the first humidity sensor (102) disposed inside at least one of the power generation cells and configured to detect a humidity of the cathode gas; the second humidity sensor (104) disposed inside at least one of the power generation cells and configured to detect a humidity of the anode gas; and the controller (20) configured to determine, on a basis of the humidity of the cathode gas detected by the first humidity sensor and the humidity of the anode gas detected by the second humidity sensor, whether the anode gas and the cathode gas are in a state in which condensation is occurring, and in a case where at least one of the cathode gas or the anode gas is determined to be in the state in which condensation is occurring, decrease a water content in the at least one of the cathode gas or the anode gas.

According to the aspect of the present invention, since the humidity sensors are provided inside the power generation cells, the amount of water in the power generation cells can be accurately detected. In addition, according to one aspect of the present invention, by adjusting the water content in at least one of the anode gas and the cathode gas, it is possible to suppress accumulation of liquid water inside the power generation cells even when the ignition is turned on. In this way, the amount of water accumulated inside the fuel cell stack can be reduced.

The power generation cell may include the membrane electrode assembly (50) and the separator (52) sandwiching the membrane electrode assembly, and the first humidity sensor and the second humidity sensor may be provided between the membrane electrode assembly and the separator. This makes it possible to accurately detect the amount of water on the flow paths in the power generation cell.

The first humidity sensor may be provided between the membrane electrode assembly and the separator in at least one of the cathode inlet space (84) that is in communication with the cathode inlet hole (70) formed in the separator and the cathode outlet space (86) that is in communication with the cathode outlet hole (72) formed in the separator, and the second humidity sensor may be provided between the membrane electrode assembly and the separator in at least one of the anode inlet space (94) that is in communication with the anode inlet hole (74) formed in the separator and the anode outlet space (96) that is in communication with the anode outlet hole (76) formed in the separator. Thus, it is possible to accurately detect the amount of water in relatively wide spaces in the flow paths of the power generation cell.

The power generation cell may include the membrane electrode assembly and the separator sandwiching the membrane electrode assembly, and the first humidity sensor and the second humidity sensor may be provided inside the membrane electrode assembly. This makes it possible to accurately detect the amount of water in the membrane electrode assembly in the power generation cell.

The membrane electrode assembly may include the electrolyte membrane (58), the anode catalyst layer (60) arranged on one surface of the electrolyte membrane, the anode diffusion layer (62) arranged between the anode catalyst layer and the separator, the cathode catalyst layer (64) arranged on another surface of the electrolyte membrane, and the cathode diffusion layer (66) arranged between the cathode catalyst layer and the separator, wherein the first humidity sensor may be arranged at least one of between the electrolyte membrane and the cathode catalyst layer or between the cathode catalyst layer and the cathode diffusion layer, and the second humidity sensor may be arranged at least one of between the electrolyte membrane and the anode catalyst layer or between the anode catalyst layer and the anode diffusion layer. Thus, it is possible to locally detect a portion of the power generation cell where liquid water is likely to be retained.

The fuel cell system may further include: the cathode pump (28) configured to supply the cathode gas to the fuel cell stack; and the humidifier (30) configured to humidify the cathode gas supplied from the cathode pump, wherein when the controller determines that the cathode gas is in the condensation state, the controller may perform at least one of the gas increasing operation of increasing supply of the cathode gas by controlling the cathode pump or the humidification decreasing operation of decreasing an extent of humidification of the cathode gas by controlling the humidifier. Thus, the water content in the cathode gas can be reduced, and the cathode gas is released from the condensation state.

The fuel cell system may further include: the circulation pump (38) disposed in the circulation path configured to allow the anode gas discharged from the fuel cell stack to return to the fuel cell stack; the ejector (40) disposed in the circulation path (32) from the circulation pump to the fuel cell stack; the anode gas tank (36) connected to the ejector and configured to store the anode gas to be supplied to the circulation path; and the discharge valve (42) disposed in the purge path (34) branched from the circulation path from the fuel cell stack to the circulation pump, wherein in the case where the controller determines that condensation is occurring in the anode gas, the controller may be configured to execute at least one of the gas supply operation in which the controller opens the discharge valve to let the anode gas discharged from the fuel cell stack flow to the purge path and controls the anode gas tank to supply the anode gas to the ejector, or the gas increasing operation in which the controller controls the circulation pump to increase the amount of the anode gas to be supplied to the ejector. Thus, the water content in the anode gas can be reduced, and the anode gas can be released from the condensation state.

The fuel cell system may further include the cooler (48) configured to cool the coolant discharged from the fuel cell stack and supply the cooled coolant to the fuel cell stack, and the controller may be configured to execute the coolant temperature increasing operation of increasing the temperature of the coolant by controlling the cooler in the case where the controller determines that condensation is occurring in at least one of the cathode gas or the anode gas. As a result, compared to a case where the coolant temperature increasing operation is not executed, it is possible to resolve condensation more quickly.

The plurality of the power generation cells may be stacked, and the first humidity sensor and the second humidity sensor may be provided for each of the power generation cells located on both ends in the stacking direction of the power generation cells and for the power generation cell located at the center in the stacking direction of the power generation cells. Thus, it is possible to set the determination condition for determining the condensation state in consideration of the temperature difference occurring in the plurality of power generation cells during the power generation operation of the fuel cell stack.

The present invention is not limited to the above disclosure, and various modifications are possible without departing from the essence and gist of the present invention.

1. A fuel cell system configured to adjust a water content in a cathode gas and an anode gas supplied to a fuel cell stack including a plurality of power generation cells stacked together, comprising:
a first humidity sensor disposed inside at least one of the power generation cells and configured to detect humidity of the cathode gas;
a second humidity sensor disposed inside at least one of the power generation cells and configured to detect humidity of the anode gas; and
a controller configured to determine, on a basis of the humidity of the cathode gas detected by the first humidity sensor and the humidity of the anode gas detected by the second humidity sensor, whether the anode gas and the cathode gas are in a state in which condensation is occurring, and in a case where at least one of the cathode gas or the anode gas is determined to be in the state in which condensation is occurring, decrease a water content in the at least one of the cathode gas or the anode gas.

2. The fuel cell system according to claim 1, wherein
each of the power generation cells comprises a membrane electrode assembly and a separator sandwiching the membrane electrode assembly, and
the first humidity sensor and the second humidity sensor are provided between the membrane electrode assembly and the separator.

3. The fuel cell system according to claim 2, wherein
the first humidity sensor is provided in at least one of a cathode inlet space that is in communication with a cathode inlet hole formed in the separator or a cathode outlet space that is in communication with a cathode outlet hole formed in the separator, and
the second humidity sensor is provided in at least one of an anode inlet space that is in communication with an anode inlet hole formed in the separator and an anode outlet space that is in communication with an anode outlet hole formed in the separator.

4. The fuel cell system according to claim 1, wherein
each of the power generation cells comprises the membrane electrode assembly and the separator sandwiching the membrane electrode assembly, and
the first humidity sensor and the second humidity sensor are provided inside the membrane electrode assembly.

5. The fuel cell system according to claim 4, wherein
the membrane electrode assembly comprises an electrolyte membrane, an anode catalyst layer arranged on one surface of the electrolyte membrane, an anode diffusion layer arranged between the anode catalyst layer and the separator, a cathode catalyst layer arranged on another surface of the electrolyte membrane, and a cathode diffusion layer arranged between the cathode catalyst layer and the separator,
the first humidity sensor is arranged at least one of between the electrolyte membrane and the cathode catalyst layer or between the cathode catalyst layer and the cathode diffusion layer, and
the second humidity sensor is arranged at least one of between the electrolyte membrane and the anode catalyst layer or between the anode catalyst layer and the anode diffusion layer.

6. The fuel cell system according to claim 1, further comprising:
a cathode pump configured to supply the cathode gas to the fuel cell stack; and
a humidifier configured to humidify the cathode gas supplied from the cathode pump,
wherein in a case where the controller determines that the cathode gas is in the state in which condensation is occurring, the controller executes at least one of a gas increasing operation of increasing supply of the cathode gas by controlling the cathode pump or a humidification decreasing operation of decreasing an extent of humidification of the cathode gas by controlling the humidifier.

7. The fuel cell system according to claim 1, further comprising:
a circulation pump disposed in a circulation path configured to allow the anode gas discharged from the fuel cell stack to return to the fuel cell stack;
an ejector disposed in the circulation path from the circulation pump to the fuel cell stack;
an anode gas tank connected to the ejector and configured to store the anode gas to be supplied to the circulation path; and
a discharge valve disposed in a purge path branched from the circulation path from the fuel cell stack to the circulation pump,
wherein in the case where the controller determines that condensation is occurring in the anode gas, the controller executes at least one of a gas supply operation in which the controller opens the discharge valve to let the anode gas discharged from the fuel cell stack flow to the purge path and controls the anode gas tank to supply the anode gas to the ejector, or a gas increasing operation in which the controller controls the circulation pump to increase the amount of the anode gas to be supplied to the ejector.

8. The fuel cell system according to claim 6, further comprising a cooler configured to cool a coolant discharged from the fuel cell stack and supply the coolant cooled by the cooler to the fuel cell stack,
wherein the controller controls the cooler to execute a coolant temperature increasing operation of increasing a temperature of the coolant in a case where the controller determines that condensation is occurring in at least one of the cathode gas or the anode gas.

9. The fuel cell system according to claim 7, further comprising a cooler configured to cool a coolant discharged from the fuel cell stack and supply the coolant cooled by the cooler to the fuel cell stack,
wherein the controller controls the cooler to execute a coolant temperature increasing operation of increasing a temperature of the coolant in a case where the controller determines that condensation is occurring in at least one of the cathode gas or the anode gas.

10. The fuel cell system according to claim 1, wherein
the plurality of the power generation cells are stacked, and
the first humidity sensor and the second humidity sensor are provided for each of the power generation cells located on both ends in a stacking direction of the power generation cells and for one of the power generation cells located at a center in the stacking direction of the power generation cells.
